(19) United States
(12) Patent Application Publication
(10) Pub. No.: US 2019/0382141 A1
(43) Pub. Date: Dec. 19, 2019

(54) UNMANNED AERIAL VEHICLE CALIBRATION DEVICE

(71) Applicant: Intel Corporation, Santa Clara, CA (US)

(72) Inventors: Gregoire Kerr, Germering (DE); Jan Stumpf, Planegg (DE)

(21) Appl. No.: 16/558,189

(22) Filed: Sep. 2, 2019

(51) Int. Cl. B64F 5/60; B64F 1/36; B64C 39/02

(52) U.S. Cl. CPC B64F 5/60; B64C 39/024; B64F 1/36

(57) ABSTRACT

Herein is disclosed an unmanned aerial vehicle sensor calibration device comprising a sensor shield, comprising an inner portion and an outer portion, and configured to shield a sensor of the unmanned aerial vehicle and to dampen transmission of a sensor input from the outer portion to the inner portion; and a sensor reference, configured to generate a reference value of the sensor input for sensor calibration within the inner portion of the sensor shield.

### TECHNICAL FIELD

Various aspects relate generally to the calibration of unmanned aerial vehicles (UAVs) and a device for same.

### BACKGROUND

UAVs are frequently used to generate data from one or more sensors. This data may subsequently be analyzed for any of a variety of purposes. Such UAVs may be used, for example, in agriculture, mineral exploitation, mining, construction, and many other purposes. Such data may be acquired at regular intervals over lengthy periods, such as weeks, months, or even years.

To best utilize the resulting data, the data should ideally be reproducible over the complete lifetime of the project. Furthermore, the data consistency and quality should be ensured. To achieve this, any drift of sensor anomalies should ideally be characterized and, if possible, corrected, such as through calibration. It is known to regularly cause a UAV to travel to a centralized location for sensor calibration/characterization activities. Such calibration procedures often need to be conducted by highly skilled personnel, which may be inefficient, particularly if the UAV otherwise operates at a remote site.

Many UAV applications involve locations that are difficult or inconvenient for humans to access and thus manual calibration may be difficult and may require significant inputs of labor. It is also known to cause the UAVs to travel long distances to a central location for charging; however, such unnecessary travel may be undesirable, an unnecessary use of energy, wear of parts, and use of time.

To avoid repeated flying to a centralized location, it is known to use a station colloquially referred to as a “drone box” (herein a “UAV box”) for repetitive, local tasks such as routine charging. These UAV boxes may act as a garage from which the UAV may be started, into which the UAV may land, or in which the UAV may recharge its batteries or upload its data. Due at least to the location of the UAV box, it may be impractical or undesirable for a human to travel to the UAV box for routine sensor calibration.

### BRIEF DESCRIPTION OF THE DRAWINGS

Throughout the drawings, it should be noted that like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings, in which:

FIG. 1 shows an unmanned aerial vehicle in a schematic view, according to various aspects;

FIG. 2 shows an unmanned aerial vehicle sensor calibration device, according to a first aspect of the disclosure;

FIG. 3 shows a configuration of a UAV sensor calibration unit according to a second aspect of the disclosure;

FIG. 4 depicts a UAV sensor calibration device according to a third aspect of the disclosure;

FIG. 5 depicts the sensor calibration device according to a fourth aspect of the disclosure; and

FIG. 6 depicts a method of unmanned aerial vehicle sensor calibration comprising shielding a sensor of the unmanned aerial vehicle and dampening transmission of a sensor input.

### DESCRIPTION

The following detailed description refers to the accompanying drawings that show, by way of illustration, specific details and aspects in which the disclosure may be practiced. One or more aspects are described in sufficient detail to enable those skilled in the art to practice the disclosure. Other aspects may be utilized and structural, logical, and/or electrical changes may be made without departing from the scope of the disclosure. The various aspects of the disclosure are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa.

The term “exemplary” may be used herein to mean “serving as an example, instance, or illustration”. Any aspect or design described herein as “exemplary” is not necessarily to be construed as preferred or advantageous over other aspects or designs.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The words “plural” and “multiple” in the description and in the claims expressly refer to a quantity greater than one. Accordingly, any phrases explicitly invoking the aforementioned words (e.g., “a plurality of (objects)”, “multiple (objects)”) referring to a quantity of objects expressly refers more than one of the said objects. The terms “group (of)”, “set (of)”, “collection (of)”, “series (of)”, “sequence (of)”, “grouping (of)”, etc., and the like in the description and in the claims, if any, refer to a quantity equal to or greater than one, i.e. one or more.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art. Any type of information, as described herein, may be handled for example via a one or more processors in a suitable way, e.g. as data.

The terms “processor” or “controller” as, for example, used herein may be understood as any kind of entity that allows handling data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” detailed herein may be understood to include any suitable type of memory or memory device, e.g., a hard disk drive (HDD), a solid-state drive (SSD), a flash memory, etc.

Differences between software and hardware implemented data handling may blur. A processor, controller, and/or circuit detailed herein may be implemented in software, hardware and/or as hybrid implementation including software and hardware.

The term “system” (e.g., a sensor system, a control system, a computing system, etc.) detailed herein may be understood as a set of interacting elements, wherein the elements can be, by way of example and not of limitation, one or more mechanical components, one or more electrical components, one or more instructions (e.g., encoded in storage media), and/or one or more processors, and the like.

The term “position” used with regard to a “position of an unmanned aerial vehicle”, “position of an object”, “position of an obstacle”, and the like, may be used herein to mean a point or region in a two- or three-dimensional space. It is understood that suitable coordinate systems with respective reference points are used to describe positions, vectors, movements, and the like. The term “flight path” used with regard to a “predefined flight path”, a “traveled flight path”, a “remaining flight path”, and the like, may be understood as a trajectory in a two- or three-dimensional space. The flight path may include a series (e.g., a time-resolved series) of positions along which the unmanned aerial vehicle has traveled, a respective current position, and/or at least one target position towards which the unmanned aerial vehicle is traveling. The series of positions along which the unmanned aerial vehicle has traveled may define a traveled flight path. The current position and the at least one target position may define a remaining flight path.

The term “map” used with regard to a two- or three-dimensional map may include any suitable way of describing positions of objects in the two- or three-dimensional space.

An unmanned aerial vehicle (UAV) is an aircraft that has the capability of autonomous flight. In autonomous flight, a human pilot is not aboard and in control of the unmanned aerial vehicle. The unmanned aerial vehicle may also be denoted as an unstaffed, uninhabited or unpiloted aerial vehicle, aircraft or aircraft system or UAV.

The unmanned aerial vehicle, according to various aspects, may include a support frame that serves as a basis for mounting components of the unmanned aerial vehicle, such as, for example, motors, sensors, mechanic, transmitter, receiver, and any type of control to control the functions of the unmanned aerial vehicle as desired. One or more of the components mounted to the support frame may be at least partially surrounded by a shell (also referred to as body, hull, outer skin, etc.). As an example, the shell may mechanically protect the one or more components. Further, the shell may be configured to protect the one or more components from moisture, dust, radiation (e.g. heat radiation), etc.

The unmanned aerial vehicle, according to various aspects, may include a camera gimbal having an independent two- or three-axis degree of freedom to properly track a target, e.g., a person or point of interest, with a tracking camera independently of an actual flight direction or actual attitude of the unmanned aerial vehicle. In some aspects, a depth camera may be used for tracking, monitoring the vicinity, providing images to a user of the unmanned aerial vehicle, etc. A depth camera may allow the association of depth information with an image, e.g., to provide a depth image. This allows, for example, the ability to provide an image of the vicinity of the unmanned aerial vehicle including depth information about one or more objects depicted in the image.

The unmanned aerial vehicle described herein can be in the shape of an airplane (e.g., a fixed wing airplane) or a copter (e.g., multi rotor copter), i.e., a rotorcraft unmanned aerial vehicle, e.g., a quad-rotor unmanned aerial vehicle, a hex-rotor unmanned aerial vehicle, an octo-rotor unmanned aerial vehicle. The unmanned aerial vehicle described herein may include a plurality of rotors (e.g., three, four, five, six, seven, eight, or more than eight rotors), also referred to as propellers. Each of the propellers has one or more propeller blades. In some aspects, the propellers may be fixed pitch propellers. The propellers may be characterized by a pressure side and a suction side, wherein the pressure side is the bottom side of the propeller and the suction side is the top side of the propeller. Propellers may have a variety of dimensions, which will be discussed throughout this disclosure. The term “height” is used herein to describe a perpendicular distance from the cord. The term “thickness” is used to describe the measurement along an axis connecting, and perpendicular to, the leading edge and the trailing edge.

The unmanned aerial vehicle may be configured to operate with various degrees of autonomy: under remote control by a human operator, or fully or intermittently autonomously, by onboard computers. The unmanned aerial vehicle may be configured to lift-off (also referred to as take-off) and land autonomously in a lift-off and/or a landing operation mode. Alternatively, the unmanned aerial vehicle may be controlled manually by a radio control (RC) at lift-off and/or landing. The unmanned aerial vehicle may be configured to fly autonomously based on a flight path. The flight path may be a predefined flight path, for example, from a starting point or a current position of the unmanned aerial vehicle to a target position, or, the flight path may be variable, e.g., following a target that defines a target position. In some aspects, the unmanned aerial vehicle may switch into a GPS-guided autonomous mode at a safe altitude or safe distance. The unmanned aerial vehicle may have one or more fail-safe operation modes, e.g., returning to the starting point, landing immediately, etc. In some aspects, the unmanned aerial vehicle may be controlled manually, e.g., by a remote control during flight, e.g., temporarily.

It is proposed to add a calibration suite and a calibration procedure to the UAV box, which may allow for an integrated pre and/or post flight calibration of the UAV payload(s). This may enable direct quality checks, therefore fostering better-validated payload data and/or may directly identify faulty parameters that may require maintenance actions to be initialized.

In addition to calibrating sensors for payload data, the procedures and concepts described herein may be extended to any UAV sensor, without limitation. This may include, but is not limited to, flight monitoring sensors, collision avoidance sensors, or otherwise.

The procedures and devices described herein may permit a UAV to be operated from a UAV box in an increasingly automated fashion. For example, upon starting a given mission, the UAV may take off, acquire the relevant data, land, and upload the data without human direct human intervention. The UAV box may be used for charging of the UAV. The UAV box may alternatively or additionally be configured to permit a connection between the UAV and the internet, a cloud service, a centralized server, or otherwise. Within this context, a device and a method for performing a sensor calibration/characterization is proposed.

The UAV may be programmed to travel to the UAV box, where it will land. The UAV box may include a hull and an opening through which the UAV enters. Once the UAV has landed, the opening of the hull may be closed over the payload sensors or over some or all of the UAV. The hull may be made of a material that partially or completely isolates the UAV from the environment domain it is measuring. For example, in the case of a ‘classical’ optical domain camera payload, once closed, the hull may block any external light-source from reaching the sensor.

The hull may additionally be equipped, in an internal portion of the hull, with a calibration arrangement. Such an arrangement may comprise, for example, a target and a sensor input source. In this scenario, the target may be placed in front of the payload, so that the payload is able to acquire measurements of the target from within the UAV box. In the event that the payload is focused at a given distance, the target may be placed behind a collimation setup, which may be configured to simulate the required distance.

The sensor input source may provide a controlled signal, which may permit the target to be measured by the payload. The sensor input source could, for example, be a light source in the event that the payload is an optical camera. If the payload is focused on thermography, the sensor input source may be a heater. In this case, the heater could be configured to reach a predetermined amount of thermal output against which the payload could be calibrated. Alternatively, it should be noted that some sensors produce their own sensor input, such as light detection and ranging (LIDAR), which does not require a separate light source. In that event, or for other sensors that do not require a separate sensor input, an additional sensor input mechanism in the UAV box may be unnecessary.

For classical optical payloads, the main calibration may be a pure geometric calibration. Such geometric calibrations may be achieved by integrating in the hull a movable geometric calibration target (e.g., the classic chessboard pattern) along with a diffused illumination source. The payload may then acquire pictures of the calibration target. The calibration target may be moved any number of times to a different location, such that the image sensor has a different vantage of the calibration target with each acquisition. For a thermography sensor, the calibration target may be, for example, a black-body or a gray-body, whose temperature could be varied. This would enable a radiometric calibration of the UAV sensor.

For agriculture monitoring, Multi-Spectral-Imagers (MSIs) are commonly used. In order to provide accurate results, these sensors require both spectral calibration (i.e., calibration for each light band to which the MSI sensor is sensitive) and radiometric calibration (i.e., what signal induces which output). According to one aspect of the disclosure, this may be achieved by placing in front of the payload a Lambertian reflective target (e.g., or a target fitting the spectral domain of the MSI) illuminated by a monochromator. Varying the monochromator wavelengths may permit the spectral calibration of the MSI by measuring resulting signals for all bands. Varying the illumination intensity and measuring the corresponding signal may permit measurement of the radiometric variability. This spectral/radiometric calibration may be complemented by a geometric calibration, as described for ‘classical’ optical domain camera systems.

The above implementations are not mutually exclusive. Depending on the configuration and/or the purpose of the UAV mission, the UAV may be equipped with a plurality of different sensors for a plurality of different purposes. For payloads embedding different sensors, or for payloads requiring different types of calibration, multiple calibration setups may be present in the UAV Box. For example, the multiple calibration setups may be configured as part of a rotating setup, in which the calibration setups and/or the UAV is/are rotated, which may permit the various calibration setups to be placed in front of the payload.

Alternatively or additionally, the sensor calibration methods described herein may be applied to a heating and/or cooling system. That is, the temperature of an internal area of the UAV box can be varied. Controlling the temperature may enable more precise characterization of the temperature dependencies, which may become critical for some imaging sensors. This may also be performed, for example, for any other environmental parameter affecting the measurement. It should be noted that sensor calibration may require various computational procedures, such as in analyzing data, comparing readings, determining deviations from standardized measurements, etc. Whatever the computations involved in the sensor calibration, there may be great flexibility in the location where the computations are performed. For example, the calibration computations may be performed in one or more of the following places: (1) if the UAV comprises a suitable processing unit, computations could be performed directly on the UAV; (2) if the UAV box comprises a suitable processing unit, computations could be performed by the UAV box; and (3) if the UAV box/UAV is connected to the internet or can otherwise transmit and receive information to/from an outside source, computations could be performed on a remote server. The computations for the calibration procedures described herein may be performed in a location according to any, or any combination of, the three above configurations. It may be assumed, however, that there is a synchronized communication between the UAV box and the UAV, and that the data can be uploaded to a processing environment.

Although the focus on the calibration devices and techniques described herein has been placed on the UAV payload, any of these devices and/or techniques may be applied to other UAV sensors. For example, they may be applied to sensors that are involved in UAV flight or navigation. These sensors may include but are not limited to inertial measurement unit (IMU) sensors, compasses, barometers/altitude sensors, stereo sensors, or otherwise. For example, IMUs may be calibrated and/or validated by applying one or more known movements to the UAV and comparing them with the IMU responses. Compasses may be calibrated and/or validated by applying a local magnetic field to the UAV. Barometers/altitude sensors may for example be calibrated and/or validated by applying different temperatures to the sensors. Stereo sensors for distance estimation and collision avoidance may be geometrically calibrated similarly to optical payloads by causing the sensors to detect movable ‘checker-board’ targets or other calibration targets.

Regardless of how the calibration device is configured, the hull can be automatically set in place and the calibration routines started upon the UAV landing in the device. For each setup, the payload may acquire its measurements and may forward them the processing unit. Any subsequent calibration device is then moved to the front of the sensor and tested. Alternatively, the UAV may be moved to face a subsequent calibration device. The processing unit can then process these measurements and calibrate the payload accordingly. If the calibration values are not within operation margins, a subsequent step may be taken. For example, in the event that satisfactory results are not reached with calibration, the calibration device and/or the UAV may send a message to an operator or other entity indicating that the UAV requires maintenance.

According to an aspect of the disclosure, retrieved calibration may be stored or uploaded to the data-processing solution and may be able to be used for processing the data acquired during the next UAV flight. Moreover, a further calibration may be applied after each flight. Comparing the retrieved values before and after the flight may allow for detection of any calibration-compromising event that might have occurred during the flight.

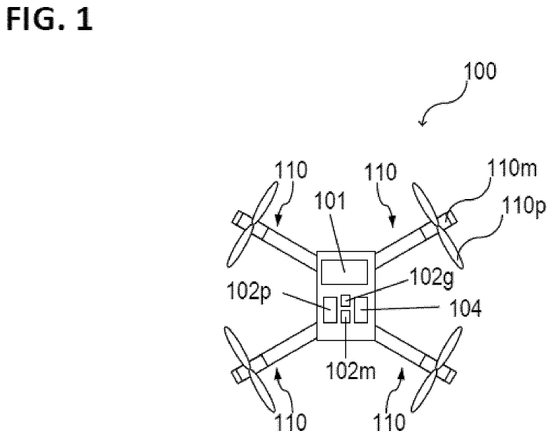

FIG. 1 illustrates an unmanned aerial vehicle 100 in a schematic view, according to various aspects. The unmanned aerial vehicle 100 may include a plurality of (e.g., three or more than three, e.g., four, six, eight, etc.) vehicle drive arrangements 110. Each of the vehicle drive arrangements 110 may include at least one drive motor 110m and at least one propeller 110p coupled to the at least one drive motor 110m. According to various aspects, the one or more drive motors 110m of the unmanned aerial vehicle 100 may be electric drive motors. Therefore, each of the vehicle drive arrangements 110 may be also referred to as electric drive or electric vehicle drive arrangement.

Further, the unmanned aerial vehicle 100 may include one or more processors 102p configured to control flight or any other operation of the unmanned aerial vehicle 100. The one or more processors 102p may be part of a flight controller or may implement a flight controller. The one or more processors 102p may be configured, for example, to provide a flight path based at least on a current position of the unmanned aerial vehicle 100 and a target position for the unmanned aerial vehicle 100. In some aspects, the one or more processors 102p may control the unmanned aerial vehicle 100 based on a map, as described in more detail below. In some aspects, the one or more processors 102p may directly control the drive motors 110m of the unmanned aerial vehicle 100, so that in this case no additional motor controller may be used. Alternatively, the one or more processors 102p may control the drive motors 110m of the unmanned aerial vehicle 100 via one or more additional motor controllers. The motor controllers may control a drive power that may be supplied to the respective motor. The one or more processors 102p may include or may implement any type of controller suitable for controlling the desired functions of the unmanned aerial vehicle 100. The one or more processors 102p may be implemented by any kind of one or more logic circuits.

According to various aspects, the unmanned aerial vehicle 100 may include one or more memories 102m. The one or more memories 102m may be implemented by any kind of one or more electronic storing entities, e.g., one or more volatile memories and/or one or more non-volatile memories. The one or more memories 102m may be used, e.g., in interaction with the one or more processors 102p, to build and/or store the map, according to various aspects.

Further, the unmanned aerial vehicle 100 may include one or more power supplies 104. The one or more power supplies 104 may include any suitable type of power supply, e.g., a directed current (DC) power supply. A DC power supply may include one or more batteries (e.g., one or more rechargeable batteries), etc.

According to various aspects, the unmanned aerial vehicle 100 may include one or more sensors 101. The one or more sensors 101 may be configured to monitor the vicinity of the unmanned aerial vehicle 100. The one or more sensors 101 may be configured to detect obstacles in the vicinity of the unmanned aerial vehicle 100. According to various aspects, the one or more processors 102p may be further configured to modify a predefined flight path of the unmanned aerial vehicle 100 based on detected obstacles to generate a collision free flight path to the target position avoiding obstacles in the vicinity of the unmanned aerial vehicle. According to various aspects, the one or more processors 102p may be further configured to reduce altitude of the unmanned aerial vehicle 100 to avoid a collision during flight, e.g., to prevent a collision with a flying object that is approaching unmanned aerial vehicle 100 on a collision course. As an example, if the unmanned aerial vehicle 100 and the obstacle may approach each other and the relative bearing remains the same over time, there may be a likelihood of a collision.

The one or more sensors 101 may include, for example, one or more cameras (e.g., a depth camera, a stereo camera, etc.), one or more ultrasonic sensors, one or more radar (radio detection and ranging) sensors, one or more lidar (light detection and ranging) sensors, etc. The one or more sensors 101 may include, for example, any other suitable sensor that allows a detection of an object and the corresponding position of the object. The unmanned aerial vehicle 100 may further include a position detection system 102g. The position detection system 102g may be based, for example, on global positioning system (GPS) or any other available positioning system. Therefore, the one or more processors 102p may be further configured to modify a predefined flight path of the unmanned aerial vehicle 100 based on data obtained from the position detection system 102g. The position detection system 102g may be used, for example, to provide position and/or movement data of the unmanned aerial vehicle 100 itself (including a position, e.g., a direction, a speed, an acceleration, etc., of the unmanned aerial vehicle 100). However, other sensors (e.g., image sensors, a magnetic sensor, etc.) may be used to provide position and/or movement data of the unmanned aerial vehicle 100. The position and/or movement data of both the unmanned aerial vehicle 100 and of the one or more obstacles may be used to predict a collision (e.g., to predict an impact of one or more obstacles with the unmanned aerial vehicle).

According to various aspects, the one or more processors 102p may include (or may be communicatively coupled with) at least one transceiver configured to provide an uplink transmission and/or downlink reception of radio signals including data, e.g., video or image data and/or commands. The at least one transceiver may include a radio frequency (RF) transmitter and/or a radio frequency (RF) receiver.

The one or more processors 102p may further include (or may be communicatively coupled with) an inertial measurement unit (IMU) and/or a compass unit. The inertial measurement unit may allow, for example, a calibration of the unmanned aerial vehicle 100 regarding a predefined plane in a coordinate system, e.g., to determine the roll and pitch angle of the unmanned aerial vehicle 100 with respect to the gravity vector (e.g. from planet earth). Thus, an orientation of the unmanned aerial vehicle 100 in a coordinate system may be determined. The orientation of the unmanned aerial vehicle 100 may be calibrated using the inertial measurement unit before the unmanned aerial vehicle 100 is operated in flight modus. However, any other suitable function for navigation of the unmanned aerial vehicle 100, e.g., for determining a position, a velocity (also referred to as flight velocity), a direction (also referred to as flight direction), etc., may be implemented in the one or more processors 102p and/or in additional components coupled to the one or more processors 102p. To receive, for example, position information and/or movement data about one or more obstacles, the input of a depth image camera and image processing may be used. Further, to store the respective information in the (e.g., internal) map of the unmanned aerial vehicle 100, as described herein, at least one computing resource may be used.

The unmanned aerial vehicle 100 may be referred to herein as UAV. However, a UAV may include other unmanned vehicles, e.g. unmanned ground vehicles, water vehicles, etc. In a similar way, the UAV may be any vehicle having one or more autonomous functions that are associated with a control of a movement of the vehicle.

However, various autonomous operation modes of a UAV may require a knowledge of the position of the UAV. Usually, the position of the UAV is determined based on GPS (Global Positioning System) information, e.g. RTK (Real Time Kinematic) GPS information. However, there may be many areas where an autonomous operation of a UAV may be desired (for inspections, rescue operations, etc.) but where the GPS information is either not available or faulty. As an example, various structures (e.g., a bridge, a building, etc.) may shield the GPS signals, so that it may not be possible for a UAV to determine its location. As another example, reflections from a water surface may disturb the GPS signals and make a GPS system of a UAV at least temporarily useless. Therefore, it may be difficult to inspect an oil platform on the ocean with an autonomously operating UAV. As another example, indoor, in tunnels, in a cave, below earth, etc., may be no GPS signals available which usually excludes many inspection cases with obstacle avoidance from customers.

UAVs may be configured as multirotor helicopters, such as, for example, quadcopters and octocopters. The specific number of propellers used for the UAV is largely immaterial to the propeller disclosed herein, which can be implemented in a quadcopters UAV, an octocopter UAV, or otherwise, without limitation. These multirotor-helicopter-type UAVs typically utilize multiple pairs of identical, fixed-pitched propellers, which may be configured to rotate in opposite directions. Such UAVs are able to independently control the rotational velocity of each propeller to control movement of the UAV. By changing the velocity of one or more of the various propellers, it is possible to generate a desired total thrust; to locate for the center of thrust both laterally and longitudinally; and to create a desired total torque, or turning force. By increasing the thrust of its rotors operating in a first direction compared to those operating in an opposite direction, the UAV is able to create a yaw movement. A UAV may increase its thrust in one or more rotors and concurrently decrease its thrust in a diametrically opposite rotor to adjust its pitch or roll. In addition to controlling their vertical and horizontal movement, such UAVs are also capable of generally maintaining a given position in the air, with little or no horizontal or vertical change, i.e. hovering.

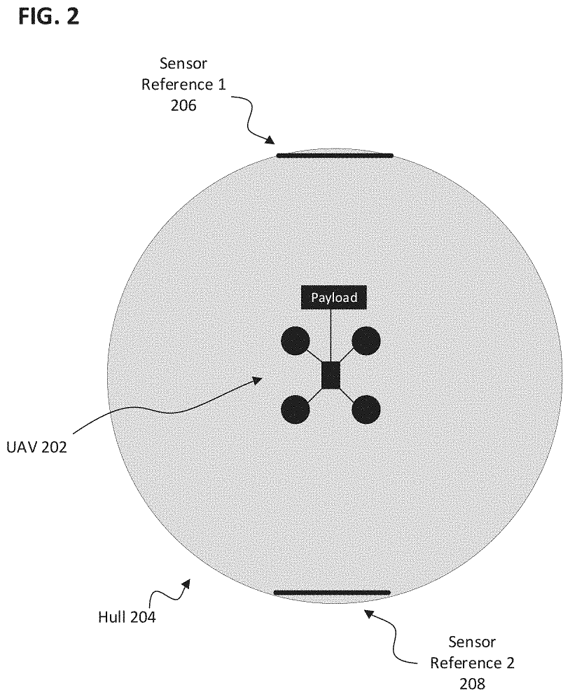

FIG. 2 depicts an unmanned aerial vehicle sensor calibration device, according to an aspect of the disclosure. An unmanned aerial vehicle 202 may enter the device, which may be surrounded by a hull 204. Within the hull 204, there may be one or more sensor references which are depicted herein as sensor reference one 206 and sensor reference two 208. The UAV 202 may be equipped with one or more payloads, and the UAV 202 may be arranged such that the payload faces a corresponding sensor reference. In this case, the payload is facing sensor reference one 206. For example, the UAV 202 may include one or more image sensors, and the sensor reference one 206 may be a sensor reference for an image sensor. For example, sensor reference one 206 may include one or more chessboard calibration images, or other calibration images for an image sensor. In this manner, the UAV 202 may enter the hull 204 of the UAV sensor calibration device and may obtain images of the sensor reference one 206 and thereby calibrate its one or more image sensors. With respect to a second or any further sensor references, such as sensor reference two 208, at least two options are possible. The first option is that the sensor that may be calibrated using sensor reference one 206 and also may be further calibrated using sensor reference two 208. In that case, the UAV 202 may rotate or be rotated such that the corresponding sensor is able to detect sensor reference two 208. An additional sensor calibration can be performed using sensor reference two 208. Another option is that the UAV 202 may be configured with more than one sensor. In this case, the sensor references, such as sensor reference one 206 and sensor reference two 208, may be configured within the hull 204 such that they correspond with the locations of the various sensors on the UAV 202 to be calibrated. For example, in the event that the UAV 202 had a first sensor in the front of the UAV and a second sensor in the rear of the UAV, the sensor references could be placed as depicted in this figure, such that sensor reference one 206 is placed in the front of the sensor calibration unit and sensor reference two 208 is placed in the rear of the sensor calibration unit. In this manner, the sensors of the UAV 202 may be calibrated simultaneously or concurrently. Alternatively, the sensors of the UAV 202 may be calibrated successively without the need for rotation or other movement of the UAV 202.

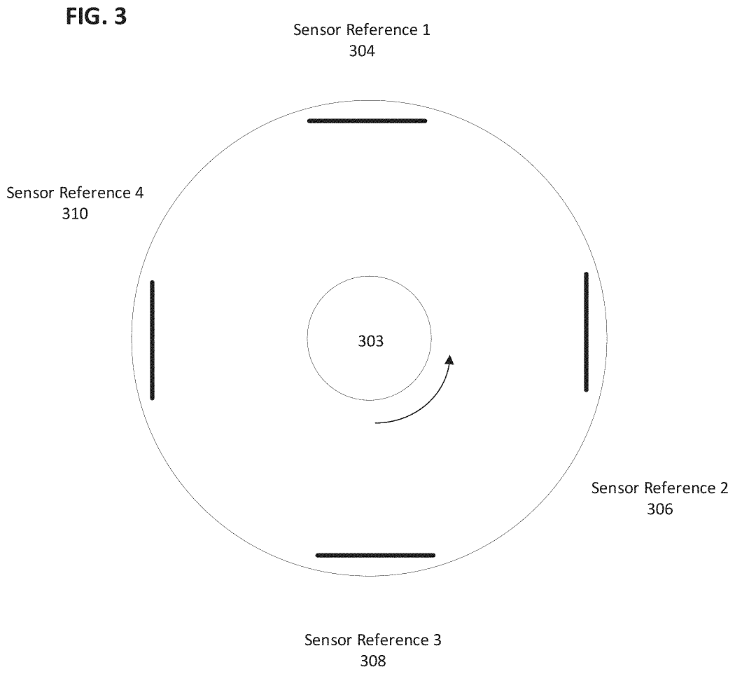

FIG. 3 shows a configuration of a UAV sensor calibration unit according to another aspect of the disclosure. In this case, the sensor calibration unit is further equipped with a landing area 303 for the UAV. The landing area may be configured to include a region that corresponds to a body of the UAV such that the UAV becomes secured within the landing region. The landing region may additionally or alternatively include the capacity to position the UAV with respect to various sensor references. For example, the landing region may be configured to rotate such that a direction of a UAV on the landing region 303 changes and one or more sensors of the UAV become directed to desired sensor references. In this example, the sensor calibration device is configured with four sensor references: sensor reference one 304, sensor reference to 306, sensor reference three 308, and sensor reference for 310. Any number of sensor references may be used, and the depiction of four sensor references herein should not be understood to be limiting.

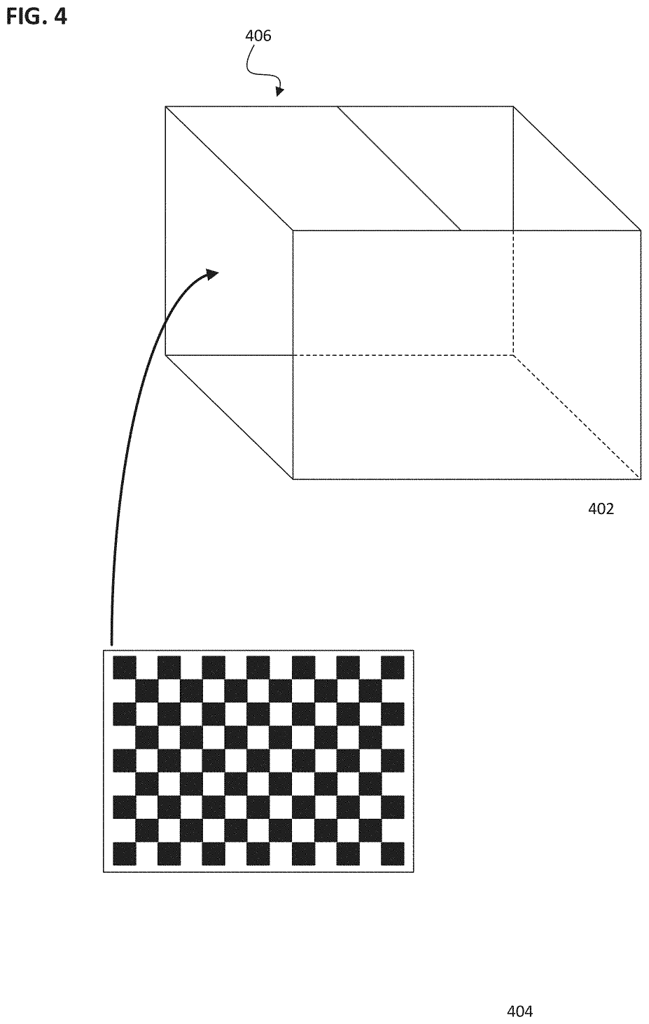

FIG. 4 depicts a UAV sensor calibration device according to another aspect of the disclosure. In this case, the sensor calibration device is configured as a box 402. It is expressly noted here and that the shape of the device may be selected based on a given implementation, available space, shape and size of the UAV, shape and size of one or more calibration references, and/or any other factor. Any particular geometric shape used in the figures herein is selected merely for demonstrative purposes and should not understand to be limiting. The hull of the sensor configuration device may include one or more openings 406. The opening in this device is depicted as two top doors, hinged on the sides, which may open to allow the UAV to land within the device from above. The opening may be placed on any face of the sensor configuration device, and the opening may be configured to open from any direction. Although the opening is depicted herein as closing and sealing, it is not necessary that the hull itself close or seal. For example, one or more faces of the sensor configuration device may remain open provided that sufficient dampening of sensor information as possible, whether with the partially open hole, or an additional sensor shield. The sensor calibration device may be equipped with a sensor reference depicted herein as 404. In this case, the sensor reference is depicted as a conventional chessboard optical configuration image. The sensor calibration reference may be any reference whether optical or otherwise, and may include, but is not limited to, a visual reference, a thermal reference, and electrical reference, a magnetic reference, and electromagnetic reference, a pressure reference, a moisture reference, or otherwise.

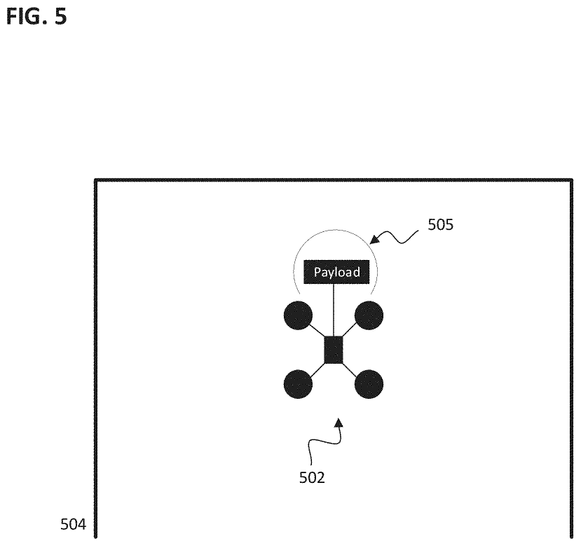

FIG. 5 depicts the sensor calibration device according to another aspect of the disclosure. In this depiction, the UAV 502 is located within the hull 504 of the sensor calibration device. In this case, the hull 504 is not closed off, meaning that at least one of the sides of the hull 504 is open. In this configuration, the sensor calibration device may be unable to dampen or isolate sensor information without an additional dampening or isolation element. This is provided by sensor shield 505, which may surround the sensor to be calibrated and dampen sensor input from an area outside of the sensor shield 505. The sensor shield 505 may be made of any material that is capable of dampening sensor input for the sensor to be calibrated. For example, if an image sensor is to be calibrated, the sensor shield may be made of a substantially opaque material. If a thermal sensor is to be calibrated, the sensor shield may be made of material that offers a measure of thermal isolation. In the event that an air pressure sensor is to be calibrated, such as a barometer, the sensor shield may form an airtight lock around the sensor, capable of maintaining an air pressure that is different from the outside air pressure. These principles may be applied to any kind of sensor. The sensor shield 505 may be configured to form a seal around the sensor to be calibrated, although this may not be necessary in some circumstances and thus may be configured otherwise. The sensor shield may be configured in any shape that is conducive to its dampening or isolating function. The sensor shield may be connected to any portion of the sensor calibration device and may be moved by the sensor calibration device up to and or around a sensor. The sensor shield may be attached to an actuating arm, to the hull, or to any other object capable of establishing a correct positioning of the sensor shield relative to the UAV sensor.

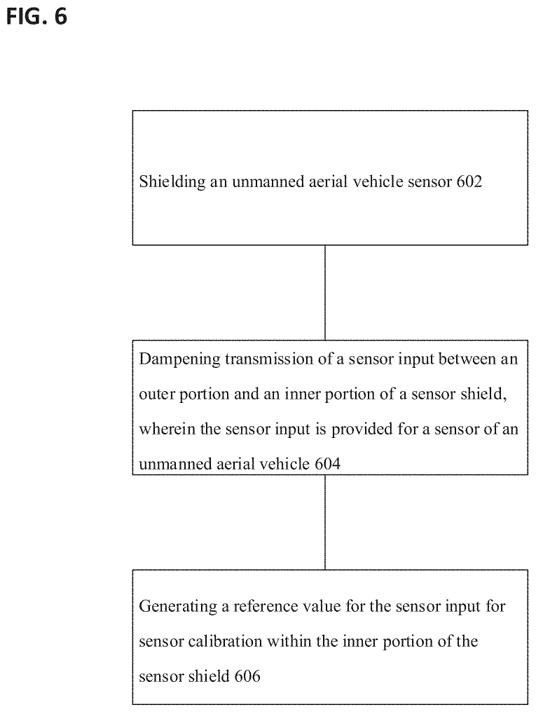

FIG. 6 depicts a method of unmanned aerial vehicle sensor calibration comprising: shielding an unmanned aerial vehicle sensor 602; dampening transmission of a sensor input between an outer portion and an inner portion of a sensor shield, wherein the sensor input is provided for a sensor of an unmanned aerial vehicle 604; and generating a reference value for the sensor input for sensor calibration within the inner portion of the sensor shield 606.

The sensor calibration device may include a sensor shield and a sensor reference. The sensor shield may be configured as a hull of the calibration device, or it may be an additional device configured to dampen sensor input from an area outside of the sensor shield. The sensor calibration device may include an optional landing area which may accommodate the UAV. The landing area may be configured to fix the position of the UAV during sensor calibration. For example, the landing area may be configured to accommodate the UAV within a specific location relative to a sensor reference and/or a sensor shield. The landing area may be configured to accommodate the UAV in a particular heading or orientation relevant to the sensor reference and/or the sensor shield. The sensor shield may be configured to cover a sensor of the UAV, to cover the UAV, and/or to surround the entire UAV. The sensor shield may be formed of multiple materials, configured to perform multiple dampening or isolating functions. For example, the sensor shield may be configured of a material that performs two or more of the following functions: light isolation (opacity), thermal isolation, electromagnetic isolation, pressure isolation, or otherwise.

The sensor reference may be combined with a sensor input generator. Some sensors require externally generated sensor input, which operates in conjunction with the sensor reference to permit sensor calibration. Such sensor input may include light, heat, electromagnetic energy, or otherwise. For example, in the event that an image (e.g., the chessboard image described, supra) is used as a sensor reference, the sensor may be unable to detect the chessboard image without a light source. This may be especially true when, for example, the sensor shield is configured to shield the sensor from all sensor input. That is, in the case of an image sensor, if the image shield is opaque and blocks all light from the sensor, the sensor will require an additional light source within an inner portion of the sensor shield to provide light. This may be a light generator, such as light emitting diode (an LED), an infrared light source, or any other electromagnetic radiation generator to which the sensor may be sensitive.

The sensor calibration device may also be equipped with a charger. The charger may be configured to charge a UAV battery. This charging may be performed using any known charging method. According to one aspect of the disclosure, the sensor calibration device may include one or more electric contacts, which are configured to establish a galvanic connection to one or more electric contacts on the UAV, such that the charger delivers electric current to the UAV battery. Alternatively or additionally, the charger may include one or more components configured to provide an inductive or capacitive connection to an element on the UAV such that a current is established in the UAV element from which the UAV battery is charged.

The sensor calibration may occur and/or any calculations necessary for sensor calibration, may occur within the UAV, within the sensor calibration device, within one or more processors external to the sensor calibration device, or in any combination thereof. According to one aspect of the disclosure, the UAV may be configured with one or more processors that are configured to perform one or more of the sensor calibration steps disclosed herein. For example, the one or more processors within the UAV may control the sensor to detect sensor information of the reference value; compare the detected sensor data arising from the reference value to a known reference standard; generate a sensor calibration value based on a difference between the detected sensor data and the known reference value; control the sensor to calibrate based on the difference; calibrate the sensor values within the one or more processors based on the detected difference between the detected sensor data and the known reference value; or any combination thereof.

According to another aspect of the disclosure, the sensor calibration device as disclosed herein may comprise one or more sensors that may be configured to control the UAV, the sensor, the sensor reference, the sensor input generator, the sensor shield, or any combination thereof. These one or more processors may receive a signal indicating that a UAV has docked within the sensor calibration device and may initiate a sensor calibration procedure. The one or more processors may be further configured to control one or more transceivers and/or modems to transmit sensor data to a server or other remote processor and to receive one or more calibration values from a server or other remote processor. The one or more processors may be configured to control the UAV to calibrate its sensor based on the received calibration value.

According to another aspect of the disclosure, the sensor calibration device may be controlled by one or more external processors. In this scenario, the sensor calibration device may include one or more local processors which are configured to communicate with one or more external processors, which may control the one or more local processors to perform the calibration operations disclosed herein. Control of said calibration operations may include, but is not limited to, causing the sensor input generator to emit sensor input; controlling the sensor to detect sensor input; controlling the transceiver and modem to transmit and/or receive detected sensor data; controlling the UAV to implement a sensor calibration based on a received sensor calibration value; rotating or positioning the UAV to align a UAV sensor with a calibration reference; or any combination thereof.

According to various aspect of the disclosure, the sensor calibration device may be configured to transmit signals to and receive signals from an external server or one or more external processors. Such transmission and reception may be performed using any known means or method of transmission and reception, whether wired or wireless, without limitation.

In the following, various examples are described that may refer to one or more aspects of the disclosure.

In Example 1, an unmanned aerial vehicle sensor calibration device is disclosed, including a sensor shield, including an inner portion and an outer portion, and configured to dampen transmission of a sensor input between the outer portion and the inner portion, wherein the sensor input is provided for a sensor of an unmanned aerial vehicle; and a sensor reference, configured to generate a reference value for the sensor input for sensor calibration within the inner portion of the sensor shield.

In Example 2, the unmanned aerial vehicle sensor calibration device of Example 1 is disclosed, further including a unmanned aerial vehicle landing area, rotatably movable within the sensor calibration device to position the sensor of the unmanned aerial vehicle to receive sensor input from the sensor reference.

In Example 3, the unmanned aerial vehicle sensor calibration device of Example 2 is disclosed, further including a motor, configured to rotate the unmanned aerial vehicle landing area to adjust an unmanned aerial vehicle heading to position the sensor of the unmanned aerial vehicle to receive sensor input from the sensor reference.

In Example 4, the unmanned aerial vehicle sensor calibration device of Example 3 is disclosed, further including one or more processors, configured to control the motor to rotate the unmanned aerial vehicle landing area to position the sensor of the unmanned aerial vehicle to receive sensor input from the sensor reference.

In Example 5, the unmanned aerial vehicle sensor calibration device of any one of Examples 1 to 4 is disclosed, wherein the sensor shield is configured to cover the sensor of the unmanned aerial vehicle.

In Example 6, the unmanned aerial vehicle sensor calibration device of any one of Examples 2 to 4 is disclosed, wherein the sensor shield is configured to cover the unmanned aerial vehicle when the unmanned aerial vehicle is landed in the unmanned aerial vehicle landing area.

In Example 7, the unmanned aerial vehicle sensor calibration device of any one of Examples 2 to 4 is disclosed, wherein the sensor shield is configured to surround the unmanned aerial vehicle when the unmanned aerial vehicle is landed in the unmanned aerial vehicle landing area.

In Example 8, the unmanned aerial vehicle sensor calibration device of any one of Examples 1 to 7 is disclosed, wherein the sensor reference is configured to perform any of generating heat, generating a magnetic field, generating an electromagnetic signal, changing an internal pressure of the sensor shield, or any combination thereof.

In Example 9, the unmanned aerial vehicle sensor calibration device of any one of Examples 1 to 8 is disclosed, wherein the sensor reference includes an image; further including an electromagnetic radiation source to generate electromagnetic radiation; wherein the electromagnetic radiation is at least partially reflected by the sensor reference and detected by the sensor of the unmanned aerial vehicle.

In Example 10, the unmanned aerial vehicle sensor calibration device of any one of Examples 1 to 9 is disclosed, wherein the sensor reference includes an image; further including an electromagnetic radiation source to generate electromagnetic radiation; wherein the electromagnetic radiation is at least partially reflected by the sensor reference and detected by the sensor of the unmanned aerial vehicle.

In Example 11, the unmanned aerial vehicle sensor calibration device of any one of Examples 1 to 10 is disclosed, further including an unmanned aerial vehicle charger, configured to deliver an electric current to a battery of the unmanned aerial vehicle.

In Example 12, the unmanned aerial vehicle sensor calibration device of any one of Examples 1 to 11 is disclosed, further including one or more processors, configured to control the unmanned aerial vehicle to calibrate the sensor of the unmanned aerial vehicle using the sensor reference value.

In Example 13, the unmanned aerial vehicle sensor calibration device of any one of Examples 1 to 12 is disclosed, wherein the sensor of the unmanned aerial vehicle is configured to generate sensor data representing the detected sensor reference value; further including one or more processors, configured to receive the sensor data and determine from the data a sensor calibration value.

In Example 14, the unmanned aerial vehicle sensor calibration device of any one of Examples 1 to 13 is disclosed, further including a modem, configured to modulate and/or demodulate a signal.

In Example 15, the unmanned aerial vehicle sensor calibration device of any one of Examples 1 to 14 is disclosed, further including a transceiver, configured to transmit sensor data, and to receive a sensor calibration value.

In Example 16, an unmanned aerial vehicle sensor calibration system is disclosed, including: an unmanned aerial vehicle; a sensor shield, including an inner portion and an outer portion, and configured to dampen transmission of a sensor input between the outer portion and the inner portion, wherein the sensor input is provided for a sensor of an unmanned aerial vehicle; and a sensor reference, configured to generate a reference value for the sensor input for sensor calibration within the inner portion of the sensor shield.

In Example 17, the unmanned aerial vehicle sensor calibration system of Example 16 is disclosed, further including a unmanned aerial vehicle landing area, rotatably movable within the sensor calibration device to position the sensor of the unmanned aerial vehicle to receive sensor input from the sensor reference.

In Example 18, the unmanned aerial vehicle sensor calibration system of Example 17 is disclosed, further including a motor, configured to rotate the unmanned aerial vehicle landing area to adjust an unmanned aerial vehicle heading to position the sensor of the unmanned aerial vehicle to receive sensor input from the sensor reference.

In Example 19, the unmanned aerial vehicle sensor calibration system of Example 18 is disclosed, further including one or more processors, configured to control the motor to rotate the unmanned aerial vehicle landing area to position the sensor of the unmanned aerial vehicle to receive sensor input from the sensor reference.

In Example 20, the unmanned aerial vehicle sensor calibration system of any one of Examples 16 to 19 is disclosed, wherein the sensor shield is configured to cover the sensor of the unmanned aerial vehicle.

In Example 21, the unmanned aerial vehicle sensor calibration system of any one of Examples 17 to 20 is disclosed, wherein the sensor shield is configured to cover the unmanned aerial vehicle when the unmanned aerial vehicle is landed in the unmanned aerial vehicle landing area.

In Example 22, the unmanned aerial vehicle sensor calibration system of any one of Examples 16 to 20 is disclosed, wherein the sensor shield is configured to surround the unmanned aerial vehicle when the unmanned aerial vehicle is landed in the unmanned aerial vehicle landing area.

In Example 23, the unmanned aerial vehicle sensor calibration system of any one of Examples 16 to 22 is disclosed, wherein the sensor reference is configured to perform any of generating heat, generating a magnetic field, generating an electromagnetic signal, changing an internal pressure of the sensor shield, or any combination thereof.

In Example 24, the unmanned aerial vehicle sensor calibration system of any one of Examples 16 to 23 is disclosed, wherein the sensor reference includes an image; further including an electromagnetic radiation source to generate electromagnetic radiation; wherein the electromagnetic radiation is at least partially reflected by the sensor reference and detected by the sensor of the unmanned aerial vehicle.

In Example 25, the unmanned aerial vehicle sensor calibration system of any one of Examples 16 to 24 is disclosed, wherein the sensor reference includes an image; further including an electromagnetic radiation source to generate electromagnetic radiation; wherein the electromagnetic radiation is at least partially reflected by the sensor reference and detected by the sensor of the unmanned aerial vehicle.

In Example 26, the unmanned aerial vehicle sensor calibration system of any one of Examples 16 to 25 is disclosed, further including an unmanned aerial vehicle charger, configured to deliver an electric current to a battery of the unmanned aerial vehicle.

In Example 27, the unmanned aerial vehicle sensor calibration system of any one of Examples 16 to 26 is disclosed, further including one or more processors, configured to control the unmanned aerial vehicle to calibrate the sensor of the unmanned aerial vehicle using the sensor reference value.

In Example 28, the unmanned aerial vehicle sensor calibration system of any one of Examples 16 to 27 is disclosed, wherein the sensor of the unmanned aerial vehicle is configured to generate sensor data representing the detected sensor reference value; further including one or more processors, configured to receive the sensor data and determine from the data a sensor calibration value.

In Example 29, the unmanned aerial vehicle sensor calibration system of any one of Examples 16 to 28 is disclosed, further including a modem, configured to modulate and/or demodulate a signal.

In Example 30, the unmanned aerial vehicle sensor calibration system of any one of Examples 16 to 29 is disclosed, further including a transceiver, configured to transmit sensor data, and to receive a sensor calibration value.

In Example 31, a method of unmanned aerial vehicle sensor calibration is disclosed including: shielding an unmanned aerial vehicle sensor; dampening transmission of a sensor input between an outer portion and an inner portion of a sensor shield, wherein the sensor input is provided for a sensor of an unmanned aerial vehicle; and generating a reference value for the sensor input for sensor calibration within the inner portion of the sensor shield.

In Example 32, the method of unmanned aerial vehicle sensor calibration of Example 31 is disclosed, further including positioning the sensor of the unmanned aerial vehicle to receive sensor input from the sensor reference.

In Example 33, the method of unmanned aerial vehicle sensor calibration of Example 32 is disclosed, further including a rotating an unmanned aerial vehicle landing area to adjust an unmanned aerial vehicle heading to position the sensor of the unmanned aerial vehicle to receive sensor input from the sensor reference.

In Example 34, the method of unmanned aerial vehicle sensor calibration of Example 33 is disclosed, further including controlling a motor to rotate the unmanned aerial vehicle landing area to position the sensor of the unmanned aerial vehicle to receive sensor input from the sensor reference.

In Example 35, the method of unmanned aerial vehicle sensor calibration of any one of Examples 31 to 34 is disclosed, further including covering the sensor of the unmanned aerial vehicle with the sensor shield.

In Example 36, the method of unmanned aerial vehicle sensor calibration of any one of Examples 32 to 34 is disclosed, further including covering the unmanned aerial vehicle with the sensor shield when the unmanned aerial vehicle is landed in the unmanned aerial vehicle landing area.

In Example 37, the method of unmanned aerial vehicle sensor calibration of any one of Examples 32 to 34 is disclosed, further including surrounding the unmanned aerial vehicle with the sensor shield when the unmanned aerial vehicle is landed in the unmanned aerial vehicle landing area.

In Example 38, the method of unmanned aerial vehicle sensor calibration of any one of Examples 31 to 37 is disclosed, further including performing any of the following with the sensor reference: generating heat, generating a magnetic field, generating an electromagnetic signal, changing an internal pressure of the sensor shield, or any combination thereof.

In Example 39, the method of unmanned aerial vehicle sensor calibration of any one of Examples 31 to 38 is disclosed, further including generating electromagnetic radiation; wherein the electromagnetic radiation is at least partially reflected by the sensor reference and detected by the sensor of the unmanned aerial vehicle.

In Example 40, the method of unmanned aerial vehicle sensor calibration of any one of Examples 31 to 39 is disclosed, further including generating electromagnetic radiation; wherein the electromagnetic radiation is at least partially reflected by the sensor reference and detected by the sensor of the unmanned aerial vehicle.

In Example 41, the method of unmanned aerial vehicle sensor calibration of any one of Examples 31 to 40 is disclosed, further including delivering an electric current to a battery of the unmanned aerial vehicle.

In Example 42, the method of unmanned aerial vehicle sensor calibration of any one of Examples 31 to 41 is disclosed, further including controlling the unmanned aerial vehicle to calibrate the sensor of the unmanned aerial vehicle using the sensor reference value.

In Example 43, the method of unmanned aerial vehicle sensor calibration of any one of Examples 31 to 42 is disclosed, further including generating sensor data representing the detected sensor reference value; and receiving the sensor data and determine from the data a sensor calibration value.

In Example 44, a non-transient computer readable medium is disclosed, configured to cause one or more processors to perform the method of any one of Examples 31 to 43.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

What is claimed is:

1. An unmanned aerial vehicle sensor calibration device comprising:
a sensor shield, comprising an inner portion and an outer portion, and
configured to dampen transmission of a sensor input between the outer portion and the inner portion,
wherein the sensor input is provided for a sensor of an unmanned aerial vehicle; and
a sensor reference, configured to generate a reference value for the sensor input for sensor calibration within the inner portion of the sensor shield.

2. The unmanned aerial vehicle sensor calibration device of claim 1, further comprising an unmanned aerial vehicle landing area, rotatably movable within the sensor calibration device to position the sensor of the unmanned aerial vehicle to receive sensor input from the sensor reference.

3. The unmanned aerial vehicle sensor calibration device of claim 2, further comprising a motor, configured to rotate the unmanned aerial vehicle landing area to adjust an unmanned aerial vehicle heading to position the sensor of the unmanned aerial vehicle to receive sensor input from the sensor reference.

4. The unmanned aerial vehicle sensor calibration device of claim 3, further comprising one or more processors, configured to control the motor to rotate the unmanned aerial vehicle landing area to position the sensor of the unmanned aerial vehicle to receive sensor input from the sensor reference.

5. The unmanned aerial vehicle sensor calibration device of claim 1, wherein the sensor shield is configured to cover the sensor of the unmanned aerial vehicle.

6. The unmanned aerial vehicle sensor calibration device of claim 2, wherein the sensor shield is configured to cover the unmanned aerial vehicle when the unmanned aerial vehicle is landed in the unmanned aerial vehicle landing area.

7. The unmanned aerial vehicle sensor calibration device of claim 1, wherein the sensor of the unmanned aerial vehicle is configured to generate sensor data representing the detected sensor reference value; further comprising one or more processors, configured to receive the sensor data and determine from the data a sensor calibration value.

8. An unmanned aerial vehicle sensor calibration system comprising:
an unmanned aerial vehicle;
a sensor shield, comprising an inner portion and an outer portion, and configured to dampen transmission of a sensor input between the outer portion and the inner portion, wherein the sensor input is provided for a sensor of an unmanned aerial vehicle; and
a sensor reference, configured to generate a reference value for the sensor input for sensor calibration within the inner portion of the sensor shield.

9. The unmanned aerial vehicle sensor calibration system of claim 8, further comprising an unmanned aerial vehicle landing area, rotatably movable within the sensor calibration device to position the sensor of the unmanned aerial vehicle to receive sensor input from the sensor reference.

10. The unmanned aerial vehicle sensor calibration system of claim 9, further comprising a motor, configured to rotate the unmanned aerial vehicle landing area to adjust an unmanned aerial vehicle heading to position the sensor of the unmanned aerial vehicle to receive sensor input from the sensor reference.

11. The unmanned aerial vehicle sensor calibration system of claim 10, further comprising one or more processors, configured to control the motor to rotate the unmanned aerial vehicle landing area to position the sensor of the unmanned aerial vehicle to receive sensor input from the sensor reference.

12. The unmanned aerial vehicle sensor calibration system of claim 8, wherein the sensor shield is configured to cover the sensor of the unmanned aerial vehicle.

13. The unmanned aerial vehicle sensor calibration system of claim 8, wherein the sensor shield is configured to surround the unmanned aerial vehicle when the unmanned aerial vehicle is landed in the unmanned aerial vehicle landing area.

14. The unmanned aerial vehicle sensor calibration system of claim 8, further comprising one or more processors, configured to control the unmanned aerial vehicle to calibrate the sensor of the unmanned aerial vehicle using the sensor reference value.

15. The unmanned aerial vehicle sensor calibration system of claim 8, wherein the sensor of the unmanned aerial vehicle is configured to generate sensor data representing the detected sensor reference value; further comprising one or more processors, configured to receive the sensor data and determine from the data a sensor calibration value.

16. A method of unmanned aerial vehicle sensor calibration comprising:
shielding an unmanned aerial vehicle sensor;
dampening transmission of a sensor input between an outer portion and an inner portion of a sensor shield;
wherein the sensor input is provided for a sensor of an unmanned aerial vehicle; and
generating a reference value for the sensor input for sensor calibration within the inner portion of the sensor shield.

17. The method of unmanned aerial vehicle sensor calibration of claim 16, further comprising positioning the sensor of the unmanned aerial vehicle to receive sensor input from the sensor reference.

18. The method of unmanned aerial vehicle sensor calibration of claim 17, further comprising a rotating an unmanned aerial vehicle landing area to adjust an unmanned aerial vehicle heading to position the sensor of the unmanned aerial vehicle to receive sensor input from the sensor reference.

19. The method of unmanned aerial vehicle sensor calibration of claim 18, further comprising controlling a motor to rotate the unmanned aerial vehicle landing area to position the sensor of the unmanned aerial vehicle to receive sensor input from the sensor reference.

20. The method of unmanned aerial vehicle sensor calibration of claim 16, further comprising covering the sensor of the unmanned aerial vehicle with the sensor shield.
